(19) United States
(12) Patent Application Publication
(10) Pub. No.: US 2010/0005841 A1
(43) Pub. Date: Jan. 14, 2010

(54) AUTO STEERING WHEEL SAFETY LOCK

(76) Inventor: MING-HUEI LIN, Kao-Hsuing (TW)

Correspondence Address: J.C. Patents, Suite 250, 4 Venture, Irvine, CA, 92618, US

(21) Appl. No.: 12/169,549

(22) Filed: Jul. 8, 2008

(51) Int. Cl. E05B 13/10

(52) U.S. Cl. 70/209

(57) ABSTRACT

An auto steering wheel safety lock includes an elongate rod, a lock core and a telescopic rod. The elongate rod has a through hole. The lock core installed in a vertical portion of an L-shaped core sleeve has a key hole. The vertical portion of the sleeve possesses a locking bar extended outward from its right side to form a wide locking groove to fit with diverse steering wheels. The core sleeve further has a horizontal portion combined with the elongate rod in a line and having a through hole communicating with the through hole of the elongate rod. The telescopic rod is movably extended in the through holes of the both, formed with plural ACME threads for engaging with the lock core to keep the telescopic rod positioned immovable in place, and having a hook located at its rear end. The hook and the vertical portion of the core sleeve are positioned at the underside of the lock. As the auto steering wheel safety lock is locked on a steering wheel, the key hole is hidden in a little space under the steering wheel, making a burglar unable to conveniently damage or even break the lock core.

### BACKGROUND OF THE INVENTION

1. Field of the Invention

This invention relates to an automobile lock, particularly to one having its key hole of a lock core positioned exactly or almost perpendicular to a main body with its opening located in an outer surface of a core body, so that the key hole is hidden under a steering wheel after fixing the auto steering wheel safety lock on a vehicle, making the lock core uneasy or unable to be damaged so as to lower chance of losing a car.

2. Description of the Prior Art

As vehicles are relatively high-priced and often parked outdoors, they are obviously the targets wanted by burglars. Therefore, in order to prevent an automobile from being stolen, except being installed with an anti-theft system, its main components are always marked with its license number (characters) or its engine number additionally to render a difficult disposal if stolen, for lowering chance of losing the automobile.

If a burglar wants to open an anti-theft lock mentioned above with a normal way, he may consider how fast he can do it to avoid from being caught. Therefore, directly destroying an anti-theft lock is a way used mostly by burglars to shorten the opening time for lessening the risk of being arrested while stealing a car. And, the methods of breaking a lock mostly used are directly damaging a lock core with an electric driller or by powerfully striking it with a hammer as they can swiftly damage the lock core to open the lock.

As shown in FIG. 1, a conventional steering lock 1, which can be easily opened by a universal key or damaged by a driller or a hammer to get opened, mainly includes a main body 10, a lock core 11 and a telescopic rod 12.

The main body 10 is provided with a through hole 100 formed axially in its center, and a hook 101 that is formed of a U-shaped metallic bar and welded at its one side as shown at the (A) side of FIG. 1, used to lock on one side of a steering wheel (S). Because the hook 101 is made of a U-shaped metallic bar, a locking groove 102 surrounded by the hook 101 is formed to have such a small opening that may not generally accommodate all sorts of wheels.

The lock core 11 is installed in a core body 110, provided with a key hole 111 located in an outside 112 of the core body 110 as shown at the (B) side of FIG. 1, such that the key hole 111 is positioned in a direction opposite to that of the hook 101. The core body 110 has its inner side 113 jointed with a base 114 provided with a through hole 115 bored axially to communicate with the through hole 100 of the main body 10 for being inserted by the telescopic rod 12.

The telescopic rod 12 is inserted in the through holes 101 and 115, provided with plural Acme threads 120 formed around its front portion to engage with the lock core 11 to keep the telescopic rod 12 positioned in place, and a hook 121 located at its rear end for locking on another side of the steering wheel (S) with its locking groove 122.

As shown in FIG. 1, while the conventional steering lock is locked on the steering wheel (S), the key hole 111 of the lock core 11 is to be positioned on a side of the steering wheel (S) near a driver's seat. In other words, the key hole 111 of the lock core 11 is located at a position with a lot of free space allowing a burglar to operate with a driller or a hammer without restriction.

### SUMMARY OF THE INVENTION

The object of this invention is to offer an auto steering wheel safety lock that is designed through a thought focusing on keeping a lock core invisibly positioned in a restricted space after fixing the steering lock on a steering wheel, so that a burglar can not conveniently damage the lock core to steal a car so as to lower his hunger for stealing a vehicle.

The characteristics of the invention are described below.

1. The lock core is installed in a vertical portion of a core sleeve, provided with a key hole positioned exactly or almost perpendicular to an elongate rod, with an opening located at an underside of the core sleeve

2. The lock core is provided with a locking bar positioned at its right side, enabling it easily fitted with diverse steering wheels.

3. When the auto steering wheel safety lock is fixed on a steering wheel, the key hole of the lock core is positioned as close as to the panel of instrument mettrs of a vehicle to get hidden in a restricted interior space under the steering wheel, enabling the lock core uneasy to be broken by a burglar, soaring an anti-theft effect.

### BRIEF DESCRIPTION OF DRAWINGS

This invention is better understood by referring to the accompanying drawings, wherein:

FIG. 1 is a side view of a conventional auto steering wheel safety lock;

FIG. 2 is a side view of a preferred embodiment of an auto steering wheel safety lock in the present invention;

FIG. 3 is a side view of the preferred embodiment of an auto steering wheel safety lock in the present invention, showing it being locked on a steering wheel;

FIG. 4 is an exploded perspective view of the preferred embodiment of an auto steering wheel safety lock in the present invention;

FIG. 5 is a perspective view of a lock core of the preferred embodiment of an auto steering wheel safety lock in the present invention; and

FIG. 6 is a perspective view of the preferred embodiment of an auto steering wheel safety lock in the present invention.

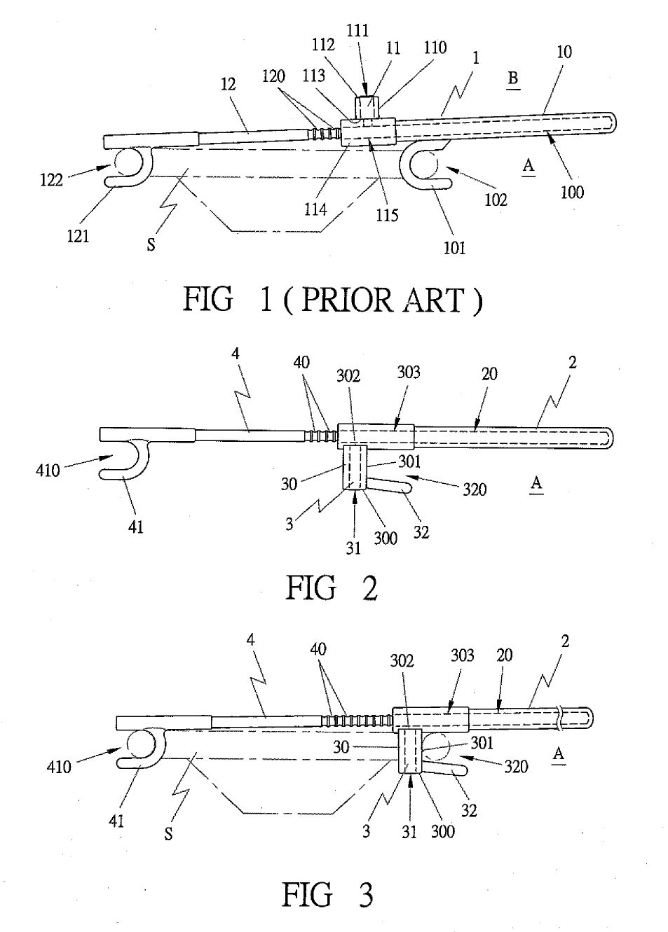

### DETAILED DESCRIPTION OF THE PREFERRED EMBODIMENT

A preferred embodiment of an auto steering wheel safety lock in the present invention mainly includes an elongate rod 2, a lock core 3 and a telescopic rod 4.

The elongate rod 2, as shown in FIGS. 2˜4, is provided with a through hole 20 formed axially in its center.

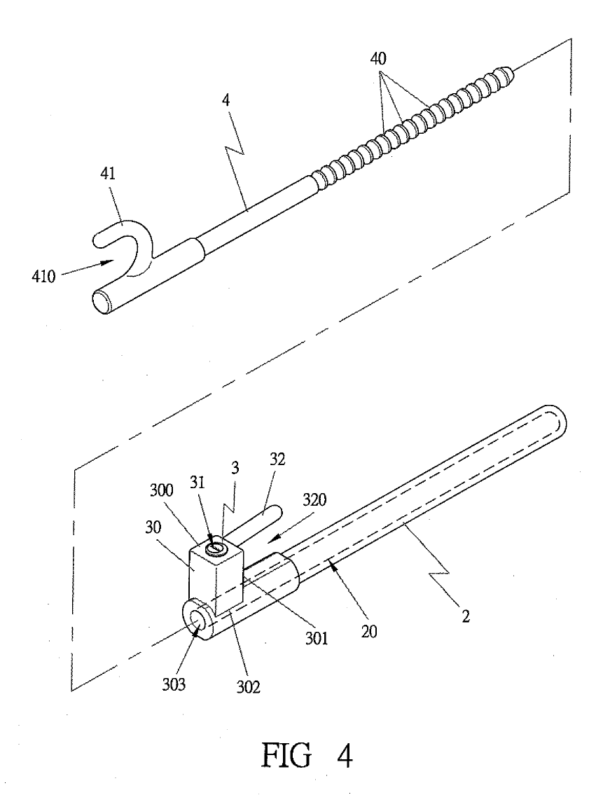

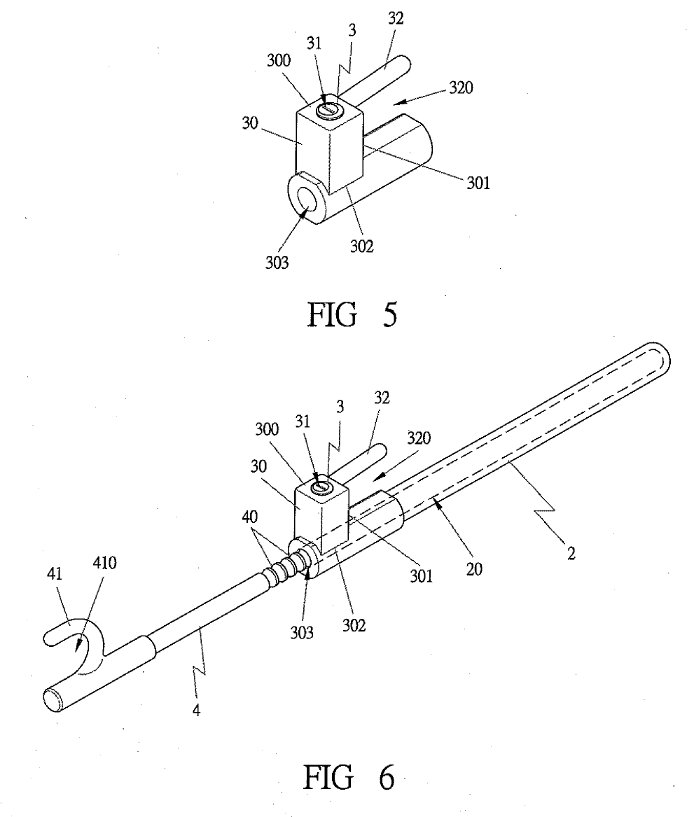

The lock core 3, as shown in FIGS. 4 and 5, is installed in a core sleeve 30, provided with a key hole 31 positioned exactly or almost perpendicular to the elongate rod 2 and located at an outer end 300 of the core sleeve 30. The core sleeve 30 is provided with a locking bar 32 directly extended outward from its right side 301 so as to have a wide locking groove 320 to adapt a rather wide steering wheel (S). Or, the locking bar 32 can be additionally fixed on the core sleeve 30 by welding and so on. The core sleeve 30 is fixed at the underside of the main body 2, provided with a through hole 303 communicating with the through hole 20 of the main body 2 to function as a telescopic rod hole. It is to be noted that the key hole 31 of the lock core 3 and the locking bar 32 are located at the underside of the elongate rod 2, or the (A) side of FIGS. 2 and 3.

The telescopic rod 4 is inserted in the telescopic rod hole, provided with plural Acme threads 40 formed with a proper length to engage with or disengage from the lock core 3 to lock or unlock the telescopic rod 4, and a hook 41 is installed at its rear end and having a locking groove 410. The hook 41 is also positioned at the same side of the elongate rod 2 as the key hole 31 of the lock core 3 and the locking bar 32 are, as shown at the (A) side of FIGS. 2 and 3. Of course, they can be as well positioned at the (B) side of FIGS. 2 and 3.

In using, as shown in FIG. 3, when the auto steering wheel safety lock is to be fixed on a steering wheel (S), the locking groove 320 of the hook 32 of the lock core 3 is first fitted with one side of the steering wheel (S). Next, the telescopic rod 4 is extended to keep the locking groove 410 of the hook 41 fitted with another side of the steering wheel (S), with the key hole 31 of the lock core 3 positioned under the steering wheel (S) and as close as to the panel of instrument mettrs of a vehicle, enabling the lock core 3 hidden behind the steering wheel (S). While a user can't directly watch the key hole 31 of the lock core 3 to open it, he can quickly get skilled by practicing repeatedly at the beginning as the key used to open the lock is completely matched with teeth of the key hole 31, so that the key can be inserted into the lock core 3 via fingers' feeling. So can the lock core 3 be opened in the dark. Therefore, the lock can be conveniently opened by experienced fingers. On the contrary, as the lock core 3 is positioned in a limited space under the steering wheel (S), it would make a burglar unable to conveniently damage or drill or strike the lock core 3, absolutely taking a long time to break the lock core 3, possible to lower chance of losing a vehicle.

While the preferred embodiment of the invention has been described above, it will be recognized and understood that various modifications may be made therein and the appended claims are intended to cover all such modifications that may fall within the spirit and scope of the invention.

What is claimed is:

1. An auto steering wheel safety lock comprising:
an elongate rod provided with a through hole, a core sleeve fixed vertically downward at a left side of said elongate rod integrally by means of a fastening member, said core sleeve having a through hole communicating with said through hole of said elongate rod to function as a telescopic rod hole;
a lock core installed in said core sleeve and provided with a key hole located at an outer end of said core sleeve, a locking bar located at a vertical lower side of said elongate rod being directly or indirectly fixed on a side surface of said core; and
a telescopic rod inserted in said telescopic rod hole and provided with plural ACME threads at a right side, a hook positioned at a left side of said telescopic rod, said key hole located at a rear side of a steering wheel after fixing said auto steering wheel safety lock on the steering wheel.

2. The auto steering wheel safety lock as claimed in claim 1, wherein said locking bar located below said elongate rod is formed with diverse shapes firmly fixed at one side of said elongate rod or said core body.

3. The auto steering wheel safety lock as claimed in claim 1, wherein said core sleeve is formed with a variety of shapes.
